(19) United States
(12) Patent Application Publication
(10) Pub. No.: US 2009/0116933 A1
(43) Pub. Date: May 7, 2009

(54) Extension apparatus for anchor bolts

(76) Inventor: Darrell Pester, Paso Robles, CA (US)

Correspondence Address: LAW OFFICES OF ANDREW SCHROEDER, P.O. Box 6731, Santa Maria, CA, 93454, US

(21) Appl. No.: 11/982,625

(22) Filed: Nov. 5, 2007

(51) Int. Cl. F16B 37/00

(52) U.S. Cl. 411/427

(57) ABSTRACT

An extension apparatus for anchor bolts includes a head and a shank. The head is comprised of a plurality of surfaces and a head bore. The bore is sized to receive an anchor bolt. The shank is an elongate cylindrical member with a shank bore sized to receive an anchor bolt.

### FIELD OF THE INVENTION

The present invention relates with the construction industry and more particularly pertains to an extension apparatus for anchor bolts.

### BACKGROUND OF THE INVENTION

One of the main concerns with respect to the construction of any home, building, or other man-made structure is the foundation upon which it is built. The relative strength or structural integrity of the foundation of a structure is especially problematic in earthquake-prone areas.

Two of the cornerstones of any structural foundations is the anchor bolt and concrete. Concrete is cost effective and moldable to virtually any shape desirable, scaleable, and simple to use and implement.

Anchor bolts are generally used to affix perimeter walls with concrete slabs or foundations, or to affix horizontal framing to vertical concrete or masonry walls. The importance of anchor bolts may be most readily illustrated in an earthquake. In the event of an earthquake the vertical walls of a structure resisting the forces are swayed horizontally in-plane. This movement, in turn, creates great tension between the interface of the ends of the walls with the concrete. Without the anchor bolts the wall would quickly detach from the concrete slab and may potentially result in the collapse of the structure.

For these reasons, many building codes specify that anchor bolts must be positioned in its final place before pouring concrete. This leads to increased strength in the foundation.

Unfortunately, in operation, anchor bolts tend to sink or settle downwards when placed in wet concrete. Moreover, the jostling about by workers and equipment can cause these anchor bolts to sink into the wet concrete even further. As a result, the anchor bolt will not extend out of the concrete slab far enough to have a plate bolted to it.

In the event an anchor bolt does not extend out of the concrete far enough, workers must often drill a hole through the concrete and fill it with epoxy or other materials in order to place another bolt in it. Naturally, this is a very labor-intensive process, which can take up to half an hour to fix. Moreover, the drilling of the hole as well as the epoxy may compromise and weaken the integrity of the structural foundation. Unfortunately, this problem occurs quite frequently: sometimes between 5-10%.

Therefore, what is clearly needed in the art is an apparatus to be used for reaching an anchor bolt, which is improperly placed in the concrete slab by being placed too low.

### SUMMARY OF THE INVENTION

It is an object of the present invention to provide a apparatus to remedy the frequent construction problem of when an anchor bolt is not positioned such that it can extend through a plate. By providing such an apparatus, it will no longer be necessary to drill holes through the concrete and use epoxy or other substances to fix the situation.

It is an object of the present invention to reduce the number of man-hours used to remedy the problems encountered by improperly placed anchor bolts. Since each improperly positioned anchor bolt can take up to half an hour to fix, the present invention could provide a substantial cost savings to many construction projects.

It is also an object of the present invention to provide a means of remedying these construction problems without compromising the structural integrity of a foundation. Since drilling holes into the concrete and the use of epoxy can weaken these foundations, the present invention would enable a builder to fix these problems without weakening the structure.

### BRIEF DESCRIPTION OF THE DRAWING FIGURES

FIG. 1 is a plan view of a preferred embodiment of the present invention.

FIG. 2 is a side view of a preferred embodiment of the present invention.

FIG. 3 is a plan view of a preferred embodiment of the present invention.

FIG. 4 is a side view of a preferred embodiment of the present invention.

FIG. 5 is an exploded view of a preferred embodiment of the present invention.

FIG. 6 is a side view of a preferred embodiment of the present invention.

FIG. 7 is a plan view of a preferred embodiment of the present invention.

FIG. 8 is a plan view of a preferred embodiment of the present invention.

FIG. 9 is a plan view of a preferred embodiment of the present invention.

FIG. 10 is a plan view of a preferred embodiment of the present invention.

### DESCRIPTION OF PREFERRED EMBODIMENTS

According to a preferred embodiment of the present invention, an extension apparatus to reach anchor bolts is used for remedying frequently occurring problem of improperly placed anchor bolts.

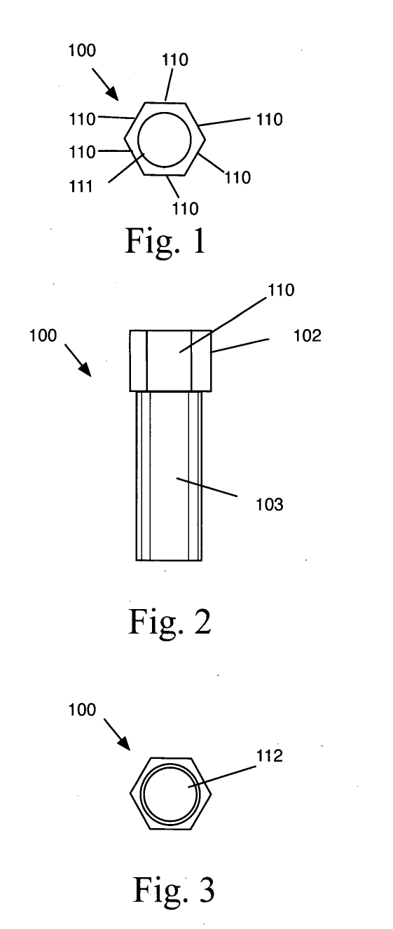

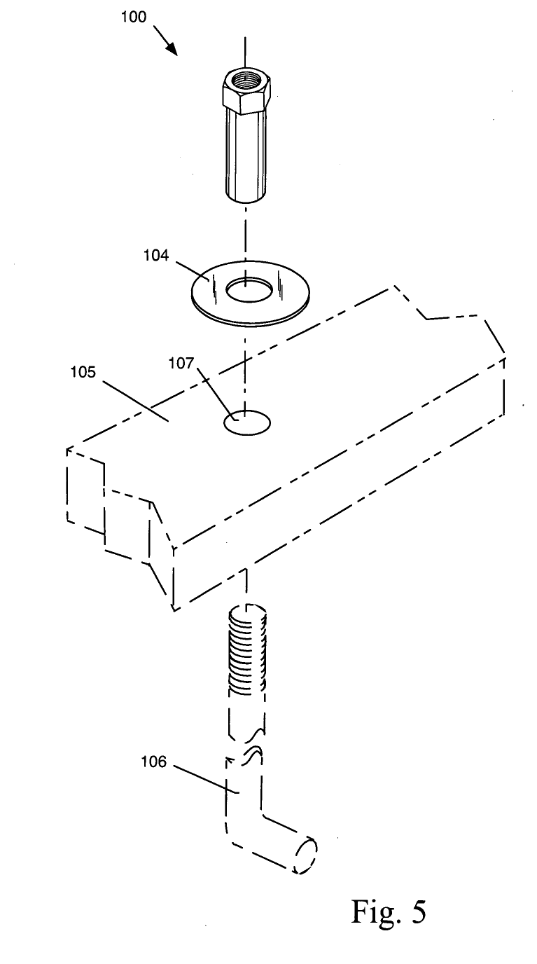

FIGS. 1-6 illustrate a preferred embodiment of the present invention. An extension apparatus 100 to reach anchor bolts includes a head 102 and a shank 103. The head is comprised of a plurality of surfaces 110 and a head bore 111. The head bore is sized to receive an anchor bolt. In some preferred embodiments the head bore is internally threaded. It should be pointed out here that the head may comprise either four, five, or six surfaces in some preferred embodiments. However, in other preferred embodiments there may be less than four or more than six surfaces. Therefore, the number of surfaces should not be construed to be limiting to the scope of the present invention.

The shank is an elongate cylindrical member with a shank bore 112 sized to receive an anchor bolt. In some preferred embodiments the shank bore is internally threaded. The head is disposed on the shank. In some preferred embodiments the apparatus may further comprise a washer 104. The washer is sized to receive the shank of the extension apparatus.

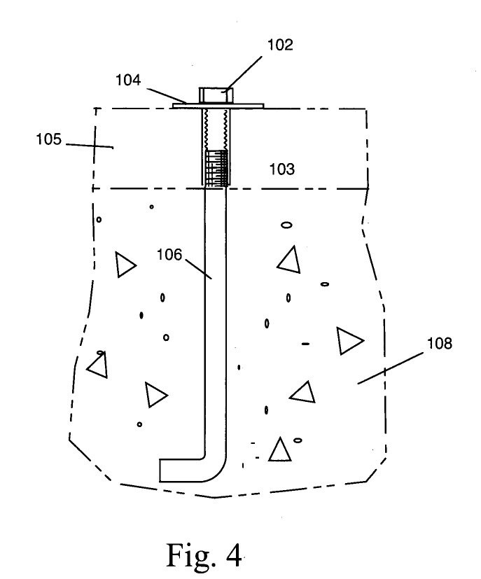

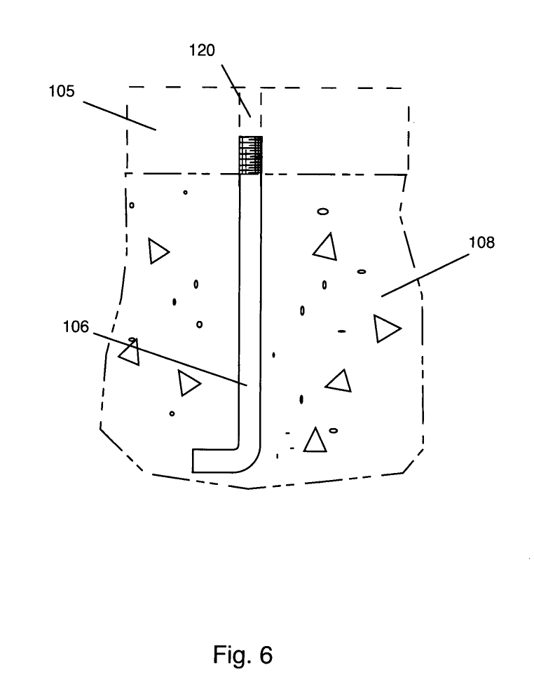

FIGS. 4 and 6 illustrate how the present invention is used in operation. FIG. 6 illustrates an example of an anchor bolt 106 which is positioned in concrete 108 underneath the surface of the 2×4 105. The extension member is inserted into the hole 120 and is screwed onto the anchor bolt in conjunction with the washer. FIG. 4 illustrates the end result of using the present invention with the frequently encountered problem on many construction sites.

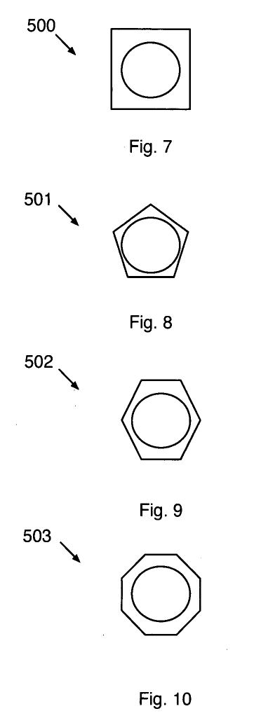

FIGS. 7-10 illustrate alternative preferred embodiments wherein the head comprises various numbers of surfaces. FIG. 7 illustrates a preferred embodiment wherein the head 500 comprises 4 surfaces. FIG. 8 illustrates a preferred embodiment wherein the head 501 comprises 5 surfaces. FIG. 9. Illustrates a preferred embodiment wherein the head 502 comprises 6 surfaces. And FIG. 10 illustrates a preferred embodiment wherein the head 503 comprises 8 surfaces.

Those skilled in the art will appreciate numerous variations in the present system, configuration and operation that are within the scope of the invention. Those skilled in the art will also appreciate how the principles illustrated in these preferred embodiments can be used in other examples of the invention. For instance, in order to be appropriately applied to the situations mentioned above, the preferred embodiments may vary in diameter, length, threading, the type of head, materials, used, etc. A particular reference number in one figure refers to the same element in all of the other figures.

Moreover, It will be apparent to the skilled artisan that there are numerous changes that may be made in embodiments described herein without departing from the spirit and scope of the invention. As such, the invention taught herein by specific examples is limited only by the scope of the claims that follow.

1. An extension apparatus for anchor bolts comprising: a head and a shank; the head is comprised of a plurality of surfaces and a head bore; the bore is sized to receive an anchor bolt; the shank is an elongate cylindrical member with a shank bore sized to receive an anchor bolt; the head is disposed on the shank.

2. The extension apparatus for anchor bolts of claim 1 further comprising a washer; the washer comprises an orifice sized to receive the shaft of the extension apparatus.

3. The extension apparatus for anchor bolts of claim 1 wherein the head bore is internally threaded.

4. The extension apparatus for anchor bolts of claim 1 wherein the shank bore is internally threaded.

5. (canceled)

6. (canceled)

7. (canceled)

8. (canceled)
